(19) United States
(12) Patent Application Publication
(10) Pub. No.: US 2012/0308153 A1
(43) Pub. Date: Dec. 6, 2012

(54) DEVICE AND METHOD OF REMOVING NOISE IN EDGE AREA

(76) Inventor: Sunghyun Hwang, Seoul (KR)

(21) Appl. No.: 13/350,034

(22) Filed: Jan. 13, 2012

(30) Foreign Application Priority Data
Jun. 3, 2011 (KR) 10-2011-0053656

(51) Int. Cl. G06K 9/40

(52) U.S. Cl. 382/264

(57) ABSTRACT

At the time of processing of an image signal from an image sensor mounted in a small electronic apparatus (e.g. a mobile apparatus), in order to remove noise, certain steps are performed, in accordance with embodiments. Edge values may be detected from an area to be smoothed to detect a feature point. Weights depending on a geometric distance with respect to the feature point may be applied to pixels distributed in the smoothed area. A brightness value as reference may be calculated in consideration of a difference in brightness between a center pixel and a peripheral pixel. Weights may be applied depending on the brightness values of the pixels to perform smoothing. It may therefore be possible to effectively remove noise while maintaining the level on the edge area.

The present application claims priority to Korean Patent Application No. 10-2011-0053656 (filed on Jun. 3, 2011), which is hereby incorporated by reference in its entirety.

### BACKGROUND

In a CMOS image sensor, like other electronic devices, undesirable noise may inevitably be generated during operation that may appear as shot noise and thermal noise. These two kinds of noise may be observed in an CMOS image sensor. Accordingly, techniques for removing these kinds of noise may be applied in many Image Signal Processing devices (ISP).

Some methods of removing or reducing noise have relatively high complexity and may require a relatively amount number of resources. However, this ielatively large amount of resources may be inappropriate or impractical for use in a CMOS image sensor designed for a mobile apparatus or similar device that must be designed to have a small physical size. In some applications, an adaptive Gaussian smoothing technique and/or a smoothing technique using a bilateral filter may be used in which an arithmetic operation is performed within a limited smoothing window.

In an adaptive Gaussian smoothing technique, the degree of smoothing may be adaptively adjusted in accordance with the presence/absence of a feature point in an image and the intensity, in order to prevent the image from being blurred. However, the overall performance heavily depends on the technique for determining a point, and the edge between the smoothed portion and the feature point may appear unnatural due to nonlinear smoothing.

In a smoothing technique using a bilateral filter, the bilateral filter may adjust the degree of smoothing using the difference in brightness between the pixels as well as the distance between the pixels. In adaptive smoothing, the degree of smoothing of each pixel may be determined in accordance with only the distance between the center pixel and the peripheral pixel. While, in a smoothing technique using a bilateral filter, there is an advantage of removing noise while keeping the feature point of the image without preliminary information on the feature point being necessary (as required in an adaptive smoothing technique). However, in a smoothing technique using a bilateral filter, there may be the problem that discontinuity occurs at the edge between the smoothed portion and the feature point, in accordance with the degree of participation of peripheral pixels in smoothing (like in an adaptive smoothing technique).

An image sensor for a mobile apparatus that is relatively small in size may include an image signal processing device which is used in an SOC-type product. Because an SOC-type product may have a limited number of resources and a limited amount of space, it may be difficult to implement a high-cost algorithm to remove noise.

### SUMMARY

Embodiments relate to a method of processing an image signal in a CMOS image sensor. In embodiments, a method removes noise in an edge area by detecting edge values in an area to be smoothed. This method may be implemented when processing an image signal from an image sensor mounted in a small electronic apparatus (e.g. such as a mobile apparatus). A method in accordance with embodiments may include at least one of the following steps: (1) Detect a feature point. (2) Apply weights depending on a geometric distance with respect to the feature point to pixels distributed in the smoothed area (3) Calculate a brightness value as a reference in consideration of a difference in brightness between a center pixel and a peripheral pixel. (4) Apply the weights depending on the brightness values of the pixels to perform smoothing. Accordingly, effectively removing noise while maintaining the level in the edge area may be implements in accordance with embodiments.

Accordingly, embodiments relate to a device and/or method of removing noise in an edge area without the limitation of edge expression due to uneven smoothing at the edge of the feature point, while effectively maintaining the quality of an edge and removing noise e.g. similar as in a bilateral filter). Embodiments relate to a device and/or method of removing noise in an edge area that minimizes and/or substantially eliminates problems related to removing noise when processing an unagc signal in an image sensor and effectively removing noise while keeping texture inherent in a subject.

### DRAWINGS

The objects and features of the present invention will become apparent from the following description of an embodiment given in conjunction with the accompanying drawings, in which:

FIG. 1 is a block diagram of a device for removing noise in an edge area with parameter adjustment, in accordance with embodiments.

FIG. 2 is an input/output diagram of a parameter adaptation unit, in accordance with embodiments.

FIGS. 3A and 3B are diagrams illustrating a Gaussian function with parameter adjustment, in accordance with embodiments.

FIGS. 4A to 4D are diagrams illustrating adaptive smoothing with parameter adjustment, in accordance with embodiments.

FIG. 5 is a block diagram of a device for removing noise in an edge area with level adjustment, in accordance with embodiments.

FIG. 6 is an input/output diagram of a level adaptation unit, in accordance with embodiments.

FIGS. 7A and 7B are diagrams illustrating adaptive smoothing with level adjustment, in accordance with embodiments.

FIGS. 5A and 8B are diagrams illustrating a Bayer image and a weight depending on a distance, in accordance with embodiments.

FIGS. 9A and 9B diagrams illustrating a weighting function for smoothing with level adjustment, in accordance with embodiments.

### DESCRIPTION

Hereinafter, the operation principle of embodiments will be described in detail with reference to the accompanying drawings. In describing the embodiments, known functions or configuration may not be described fully if that subject matter is well established to one of ordinary skill in the art. The following terms are defined in consideration of functions in the embodiments of the invention, and may vary in accordance with intentions of a user or an operator or according to usual practice. Therefore, the definitions of the terms should be interpreted on the basis of the entire content of the specification.

Embodiments relate to a technique for appropriately adjusting the operation of a bilateral filter in accordance with the presence/absence of an edge in an image and the direction of the edge, thereby minimizing the influence of noise in an edge area. In order to suppress the influence of noise, the embodiments relate to methods which adaptively adjust the operation of the bilateral filter. In some embodiments, a method (e.g. a parameter adjustment method) may adjust the parameters of a Gaussian function for determining a weight in accordance with a geometric distance using a bilateral filter. In other embodiments, a method (e.g. a level adjustment method) may adjust the reference level of a Gaussian function for determining a weight in accordance with brightness of each pixel.

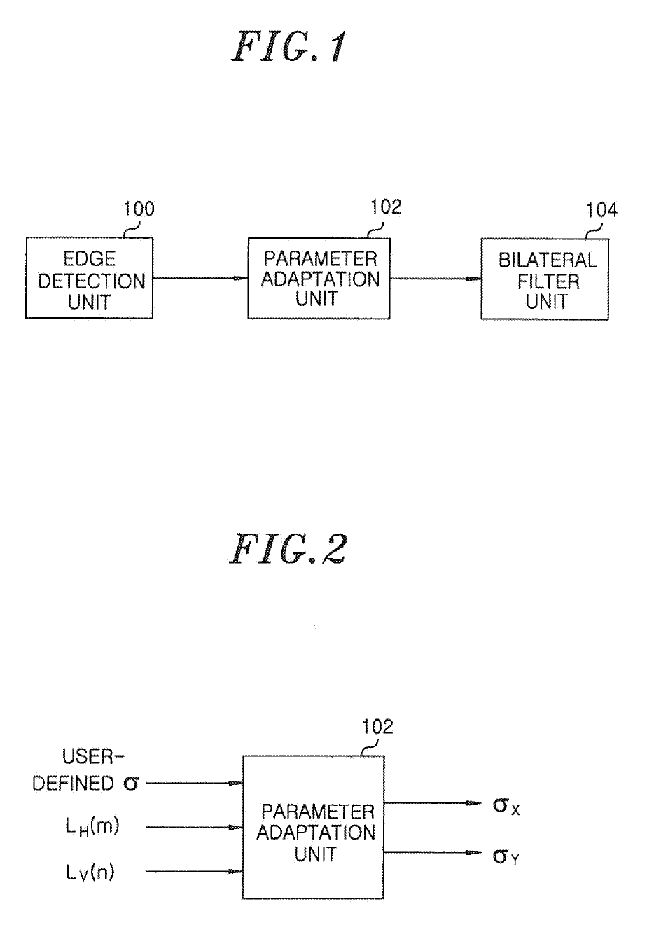

FIG. 1 is a block diagram of a device configured to remove noise in an edge area by adjusting the parameters of a Gaussian function for determining a weight in accordance with a geometric distance using a bilateral filter, in accordance with embodiments. An edge detection unit 100 may calculate edge values LH(n) and LV(m) by Equation 1 for each pixel in an area to be smoothed to determine the intensity and direction of a feature point in the area to be smoothed.

L_{H}(n)=|F(m,n−1)−2F(m,n)+F(m,n+1)|

L_{V}(n)=|F(m−1,n)−2F(m,n)+F(m+1,n)| [Equation 1]

Equation 1 (above) represents the horizontal intensity LH(n) and the vertical intensity LV(m) of a feature point, in accordance with embodiments. Although in Equation 1, an example has been described where Laplacian calculations are used to extract an edge, the edge values may be calculated using modified Laplacian calculations or a method which adds a gradient to Laplacian calculations. The extracted edge values LH(n) and LV(m) may be transmitted to a parameter adaptation unit 102.

FIG. 2 shows the input/output of signals in the parameter adaptation unit 102, in accordance with embodiments. The parameter adaptation unit 102 may determines the shape of a Gaussian function, which adjusts the degree of participation of pixels in smoothing in accordance with a geometric distance between a center pixel and a peripheral pixel in a smoothing-target area, from among two functions of a bilateral filter. A Gaussian function G(m,n) which may be determined by the parameter adaptation unit 102 may be expressed by Equations 2, 3, and 4 (below), in accordance with embodiments.

$$\begin{matrix}{G}_{x} ( m ) {\vert}_{atF ( i , j )} = \frac{1}{2 π {σ}_{x}^{2}} {e}^{- \frac{{( n - i )}^{2}}{2 {σ}_{x}^{2}}} & [ Equation 2 ] \\ {G}_{y} ( n ) {\vert}_{atF ( i , j )} = \frac{1}{2 π {σ}_{y}^{2}} {e}^{- \frac{{( n - j )}^{2}}{2 {σ}_{y}^{2}}} & [ Equation 3 ] \\ G ( m , n ) {\vert}_{atF ( i , j )} = {G}_{y}^{T} \cdot {G}_{x} & [ Equation 4 ]\end{matrix}$$

As shown in Equations 2, 3, and 4 (above), a two-dimensional Gaussian function G(m,n) for an N×M (0≦i, m≦M−1, 0≦j, n≦N−1) discrete input image may be obtained by an inner product of a one-dimensional Gaussian function Gx(m) in the horizontal direction and a one-dimensional Gaussian function Gy(n) in the vertical direction. Parameters x and y of the one-dimensional Gaussian functions may be appropriately adjusted to arbitrarily generate a two-dimensional Gaussian function G(m,n), in which different weights are distributed in the horizontal or vertical direction.

When determining the Gaussian function depending on a geometric distance, in accordance with embodiments, the parameter adaptation unit 102 adjusts the values of x and y for determining the shape of the Gaussian function using the edge values detected by the edge detection unit 100, thereby performing adaptive parameter adjustment depending on the edge values of the smoothing-target area. The relationship between edge values LH and LV and the parameters x and y of the Gaussian function can be defined by Equation 5 (below), in accordance with embodiments.

$${σ}_{x} = σ \frac{{L}_{H}}{{L}_{V} + {L}_{H}} \\ {σ}_{y} = σ \frac{{L}_{V}}{{L}_{V} + {L}_{H}} \qquad [ Equation 5 ]$$

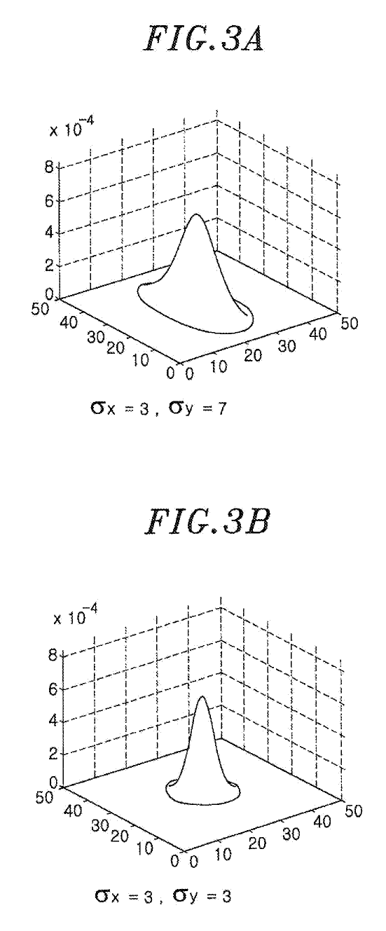

FIGS. 3A and 3B show an example of a two-dimensional Gaussian function generated for smoothing, by applying the edge values input from the edge detection unit 100 in the parameter adaptation unit 102. FIG. 3B shows an example of a Gaussian function, according to the related art, in which the values of x and y are defined in advance are may be maintained constant. FIG. 3A shows that the values of x and y are adjusted in accordance with the edge values and the shape of the Gaussian function may adaptively change, in accordance with embodiments. In embodiments, when the shape of the Gaussian function is adaptively changed, the pixels in the edge area may be more accurately smoothed.

When the values of x and y of the Gaussian function for smoothing are determined in the parameter adaptation unit 102, the bilateral filter unit 104 may apply the determined Gaussian function to bilateral filtering. The bilateral filter unit 104 may calculate a second Gaussian function I(m,n) from among two functions constituting a bilateral filter by Equation 6 (below) and may determine the degree of participation of each pixel in smoothing on the basis of a difference in brightness between a center pixel and a peripheral pixel, in accordance with embodiments.

$$I ( m , n ) {\vert}_{atF ( i , j )} = \frac{1}{( 2 {πσ}_{I}^{2} )} {e}^{- \frac{{( F ( m , n ) - F ( i , j ) )}^{2}}{2 {σ}_{I}^{2}}} \qquad [ Equation 6 ]$$

As described above, when the two Gaussian functions are determined in the bilateral filter unit 104, the bilateral filter unit 104 filters an input image F(i,j) may applying the two Gaussian functions as a filter and outputs an input image with noise removed. At this time, the input image F(i,j) subjected to bilateral filtering may be defined as FS(i,j) in Equation 7 (below) using Equations 4 and 6, which are the two Gaussian functions applied in the bilateral filter unit 104.

$${F}_{s ( i , j )} ( n ) = \frac{1}{C} {\sum }_{n = 0}^{N - 1} {\sum }_{m = 0}^{M - 1} G ( m - i , n - j ) I ( m - i , n - j ) F ( m - i , n - j ) \\ 0 \leq m , i \leq M - 1 , 0 \leq n , j \leq N - 1 \qquad [ Equation 7 ]$$

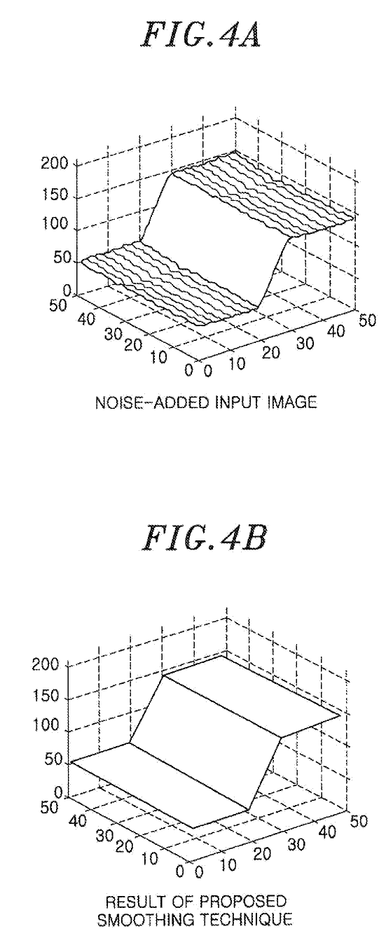

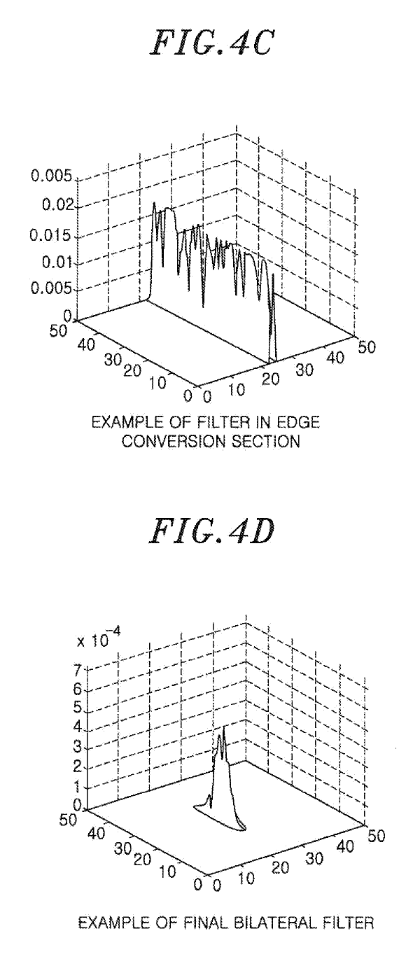

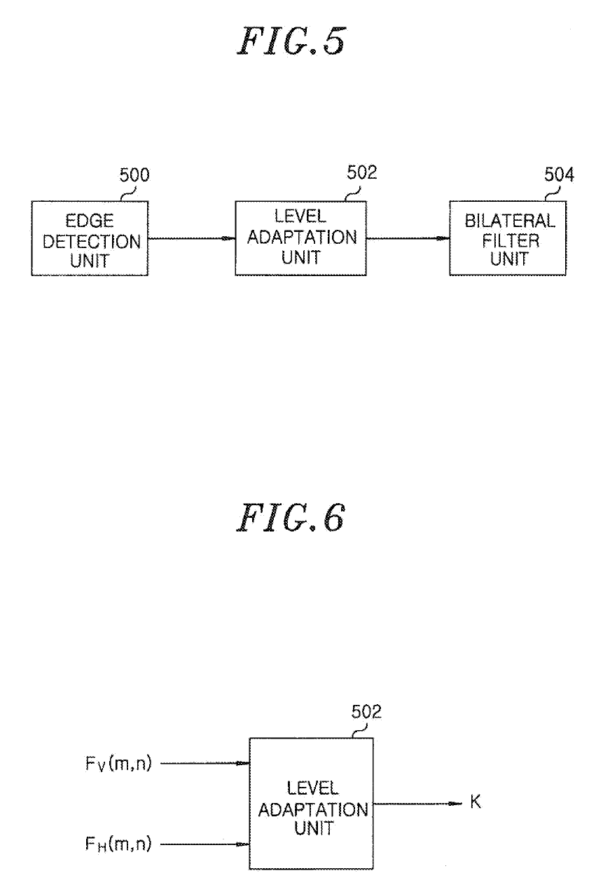

FIGS. 4A to 4D show a parameter-adjusted bilateral filter and an example of a noise-removed image using the bilateral filter, in accordance with embodiments. FIG. 4C shows an example of a filter which is generated with parameter adjustment in an edge conversion section generated in the bilateral filter unit 104, in accordance with embodiments. FIG. 4D shows an example of a final bilateral filter, in accordance with embodiments.

FIG. 4A shows a two-dimensional stepped input image with noise, in accordance with embodiments. FIG. 4B shows a noise-removed image subjected to noise removal through a bilateral filter finally generated in the bilateral filter unit 104 shown in FIG. 4D in accordance with embodiments. As shown in FIG. 4B, in accordance, with embodiments, parameter adjustment may be adaptively accomplished in accordance with the edge values for the pixels distributed in the smoothed area, such that noise is effectively removed.

FIG. 5 is a block diagram of a device for removing noise in an edge area, which determines a weight in accordance with a difference in brightness between pixels and adaptively adjusts the reference brightness level of the Gaussian function to remove noise, in accordance with embodiments. An edge detection unit 500 and a bilateral filter unit 504 may be the same as those in devices that remove noise for parameter adjustment of FIG. 1, in accordance with embodiments. In embodiments, in a level adjustment technique, a level adaptation unit 502 may be used instead of the parameter adaptation unit 102 in the parameter adjustment technique.

The edge detection unit 500 may calculate the edge values LH(n) and LV(m) by Equation 1 for each pixel in an area to be smoothed to determine the intensity and direction of a feature point in the area to be smoothed. The extracted edge values LH(n) and LV(m) may be transmitted to the level adaptation unit 502. The level adaptation unit 502 may function to adaptively adjust a brightness value (the value F(i,j) of a center pixel to be smoothed in Equation 6) as reference in the Gaussian function for determining a weight in accordance with the brightness value of each pixel on the basis of a feature point near the center pixel for the pixels in the smoothed area.

FIG. 6 is an input/output diagram of signals of the level adaptation unit 502, in accordance with embodiments. The level adaptation unit 502 may substitute the brightness value F(i,j) of the center pixel in the smoothed area expressed by Equation 6 with the reference brightness value, such that a constituent function of a bilateral filter which is used in the bilateral filter unit 504 may be determined. In embodiments, when the brightness value F(i,j) of the center pixel in Equation 6 is substituted with the reference brightness value which is output from the level adaptation unit 502, a constituent function I(m,n) for bilateral filtering of the bilateral filter unit 504 may be expressed by Equation 8 (below), in accordance with embodiments,

$$I ( m , n ) {\vert}_{atF ( i , j )} = \frac{1}{( 2 {πσ}_{I}^{2} )} {e}^{- \frac{{( F ( m , n ) - K )}^{2}}{2 {σ}_{I}^{2}}} \qquad [ Equation 8 ]$$

In Equation 8, K represents a brightness value as a reference and the value of K may be determined by Equation 9 on the basis of the edge values LH and LV obtained by the edge detection unit 500.

$$K = {F}_{V} ( m , n ) \frac{{L}_{V}}{{L}_{H} + {L}_{V}} + {F}_{H} ( m , n ) \frac{{L}_{H}}{{L}_{H} + {L}_{V}} \qquad [ Equation 9 ]$$

In embodiments, FV in Equation 9 represents the reference brightness value in the vertical direction, and FH represents the reference brightness value in the horizontal direction. FV and EH are calculated by Equation 10, in, accordance with embodiments.

F_{V}(m,n)=(F(m,n−1)+2F(m,n)+F(m,n+1))/4

Fᵥ(m,n)=(F(m−1,n)+2F(m,n)+F(m+1,n))/4 [Equation 10]

In embodiments, Equation 10 shows an example where the brightness level is thinned. The degree of thinning of the reference brightness alues FV and FH may be defined in various forms. The process of obtaining the reference brightness value K described above may thin the value along the edge in the peripheral portion with respect to the center pixel, to which the bilateral filter may be applied thereby allowing more pixels on the edge to participate in smoothing. As a result, in accordance with embodiments, it may be possible to resolve problems in related art bilateral filters of an edge of an object in an image being uneven due to the effect of noise even after smoothing.

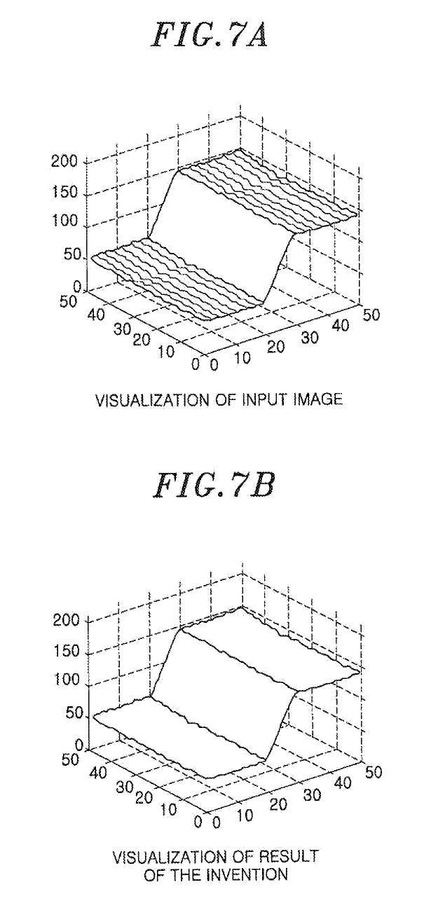

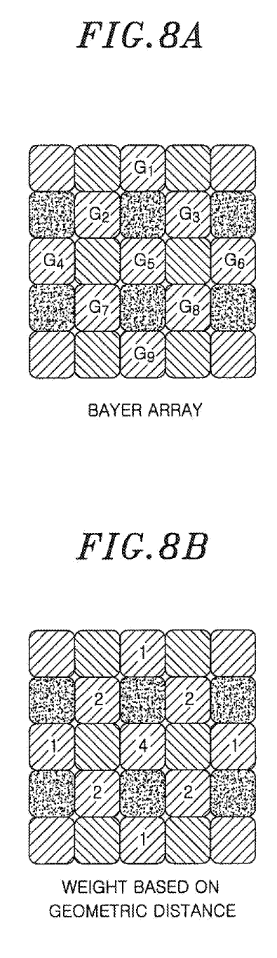

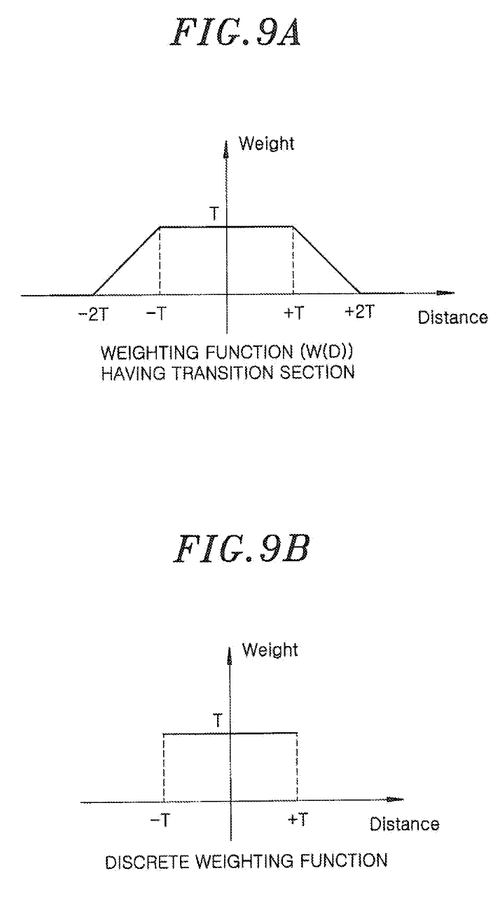

FIGS. 7A and 7B are diagrams illustrating the smoothing result using the level adjustment method, in accordance with embodiments. FIG. 7A is a diagram illustrating a visualization of a two-dimensional stepped input image, in accordance with embodiments. As shown in FIG. 7B, with bilateral filtering by a level adjustment method, it is shown that noise may be effectively removed, such that smoothing may be accomplished more evenly.

The above described embodiments relate to adaptive smoothing techniques in which a weight depending on to a geometric distance and a difference in brightness is determined, and a Gaussian function is used as a function for applying the weight. The description below relates to embodiments in which a simplified function compared to the Gaussian function is applied to remove noise.

FIGS. 8A and 8B show a Bayer image which is subjected to a technique for removing noise and a weight based on a geometric distance, in accordance with embodiments. As shown in FIG. 8A (in accordance with embodiments) a Bayer array in which the center pixel is green is defined as an input image and it is assumed that an operation area to be smoothed is 5×5. In a first step for simplification, the Gaussian function for determining a weight in accordance, with a geometric distance in Equations 2, 3, and 4 may be shaped as shown in FIG. 8B, in accordance with embodiments.

As defined in FIGS. 8A and 8B, a fixed weight may be allocated to each pixel within a smoothing, window, thereby approximating the weight distribution in a form similar to the Gaussian function and limiting the degree of smoothing. A pixel value G′ which is the smoothing result for each pixel of a Bayer image may be expressed by Equation 11 (below), in accordance with embodiments.

G′=(G′₁+G′₂+G′₃+G′₄+G′₅+G′₆+G′₇+G′₈+G′₉)/Σ_{N=1}⁹W_{N} [Equation 11]

In Equation 11, all the values for smoothing are secondary correction values obtained by calculating the difference in brightness of the pixels with respect to the center pixel as expressed in Equation 8 and applying a weight to each pixel, in accordance with embodiments. In other words, in accordance with embodiments, instead of the Gaussian function in Equation 10, a simplified function may be applied.

FIGS. 9A and 913 show an example of a weighting function for smoothing, in accordance with embodiments. Referring to FIGS. 9A and 9B, in accordance with embodiments, a distance corresponding to the x axis may represents a difference in brightness between a center pixel and a peripheral pixel and the degree of smoothing may be adjusted using a threshold value T (e.g. instead of τ in Equation 8). In embodiments, a distance DN with respect to an arbitrary pixel GN in the Bayer image shown in FIG. 8A may be defined by Equation 12 (below).

$${D}_{N} = \vert K - {G}_{N} \vert \qquad [ Equation 12 ]$$

In Equation 12, K represents a representative value obtained by the level adjustment technique in Equation 9. With the use of the thus-obtained distance and the weighting function of FIG. 9, it may be possible to obtain the weight for each pixel, in accordance with embodiments. Taking into consideration the weight obtained by the level adjustment technique and the weight depending on the distance defined in FIG. 8B, it may be possible to calculate a final weight to be applied to each pixel. The final weight W for each pixel may be calculated by Equation 13 (below), in accordance with embodiments.

W₁=1×W(|K−G₁|)

W₂=4×W(|K−G₂|)

W₃=2×W(|K−G₃|)

W₄=1×W(|K−G₄|)

W₅=4×W(|K−G₅|)

W₆=1×W(|K−G₆|)

W₇=2×W(|K−G₇|)

W₈=2×W(|K−G₈|)

W₉=1×W(|K−G₉|) [Equation 13]

When the final weight W for each pixel obtained by Equation 13 is applied to each pixel, the pixel value G having the final weight applied thereto may be obtained by Equation 14 (below), in accordance with embodiments.

G′₁=W₁G₁

G′₂=W₂G₂

G′₃=W₃G₃

G′₄=W₄G₄

G′₅=W₅G₅

G′₆=W₆G₆

G′₇=W₇G₇

G′₈=W₈G₈

G′₉=W₉G₉ [Equation 14]

As described above, in accordance with embodiments, at the time of processing of an image signal from an image sensor mounted in a small electronic apparatus, such as a mobile apparatus, in order to remove noise, edge values may be detected from an area to be smoothed to detect a feature point. Weights depending on a geometric distance with respect to the feature point may be applied to pixels distributed in the smoothed area (in accordance with embodiments). A brightness value as a reference may be calculated in consideration of a difference in brightness between a center pixel and a peripheral pixel (in accordance with embodiments). Weights may be applied depending on the brightness values of the pixels to perform smoothing (in accordance with embodiments). Therefore, in embodiments, it is possible to effectively remove noise while maintaining the level on the edge area.

In accordance with embodiments, a device may remove noise in an edge area and such a device may include at least one of (1) An edge detection unit which detects edge values in the horizontal and vertical directions from an input image and extracts feature point information of the input image using the detected edge values. (2) A parameter adaptation unit which adjusts the parameters of a distance-dependent weighting function for smoothing of the input image using the edge salues detected by the edge detection unit and the feature point information. (3) A bilateral filter unit which performs smoothing on the input image using a distance-dependent weighting function, to which the parameters adjusted by the parameter adaptation unit are applied.

The bilateral filter unit may change the shape of the weighting function to correspond to the adjusted parameters, in accordance with embodiments. The bilateral filter unit may perform smoothing by applying the corresponding value of the weighting function depending on the geometric distance from the feature point to each pixel in the input image as a weight value.

Embodiments relate to a device for removing noise in an edge area, including at least one of (1) An edge detection unit which detects edge values in the horizontal and vertical directions from an input image and extracts feature point information of the input image using the detected edge values. (2) A level adaptation unit which adjusts a reference brightness level value of a center pixel to be smoothed in the input image on the basis of the edge values and the feature point information. (3) A bilateral filter unit which determines a weighting function depending on a difference in brightness between pixels using the reference brightness level value adjusted by the level adaptation unit, and performs smoothing on the input image using the determined weighting function.

In embodiments, the bilateral filter unit may change the shape of the weighting function to correspond to the reference brightness level value. The bilateral filter unit may calculate a relative distance in accordance with a difference in brightness from the center pixel for each pixel in the input image, and may perform smoothing by applying the corresponding value of the weighting function depending on the calculated distance as a weight value. In embodiments, the bilateral filter unit may calculate a relative distance in accordance with a difference in brightness from the center pixel for each pixel in the input image, may apply a prescribed first value to each pixel at a distance corresponding to a first area from the center pixel as a weight value, and may inhibit the application of a weight value depending on a distance to pixels outside the first area.

In embodiments, a bilateral filter unit may perform at least one of (1) Calculate a relative distance in accordance with a difference in brightness from the center pixel for each pixel in the input image. Apply a prescribed first value to each pixel at a geometric distance corresponding to a first area from the center pixel as a weight value, (3) Apply a weight value, which linearly decreases depending on a distance, to each pixel in a second area at a given distance from the first area.

The bilateral filter unit may apply a weight value depending on a geometric distance from the center pixel before applying a weighting function depending on the difference in brightness to each pixel of the input image, in accordance with embodiments.

Embodiments relate to a device for removing noise in an edge area. In accordance with embodiments, the device may include at least one of: (1) An edge detection unit which detects edge values in the horizontal and vertical directions from an input image and extracts feature point information of the input image using the detected edge values. (2) A parameter adaptation unit which adjusts the parameters of a first distance-dependent weighting function for smoothing the input image using the edge values detected by the edge detection unit and the feature point information. (3) A level adaptation unit which adjusts a reference brightness level value of a center pixel to be smoothed in the input image on the basis of the edge values and the feature point information. (4) A bilateral filter unit which determines a second weighting function depending on a difference in brightness between pixels using the reference brightness level value and performs smoothing on the input image by applying both the first weighting function and the second weighting function.

Embodiments relate to a method of removing noise in an edge area. In accordance with embodiments, the method may include at least one of: (1) Detecting edge values in the horizontal and the vertical directions from an input image. (2) Extracting feature point information of the input image for smoothing using the detected edge values. (3) Adjusting the parameters of a distance-dependent weighting function for smoothing of the input image using the edge values and the feature point information. (4) Performing smoothing on the input image using the weighting function, to which the adjusted parameters are applied.

In embodiments, said performing smoothing may include changing the shape of the weighting function to correspond to the adjusted parameters, and performing smoothing by applying the corresponding value of the weighting function depending on a geometric distance from the feature point to each pixel in the input image as a weight value.

Embodiments relate to a method of removing noise in an edge area. In accordance with embodiments, the method may include at least one of: (1) Detecting edge values in the horizontal and vertical directions from an input image. (2) Extracting feature point information of the input image for smoothing using the detected edge values. (3) Adjusting a reference brightness level value of a center pixel to be smoothed in the input image on the basis of the edge values and the feature point information. (4) Determining a weighting function depending on a difference in brightness between pixels using the reference brightness level value and performing smoothing on the input image using the weighting function.

In embodiments, said performing smoothing may include at least one of: (a) Changing the shape of the weighting function to correspond to the reference brightness level value. (b) Calculating a relative distance in accordance with a difference in brightness from the center pixel for each pixel in the input image. (c) Performing smoothing by applying the corresponding value of the weighting function depending on the calculated distance as a weight value.

In embodiments, performing smoothing may include at least one of: (a) Changing the shape of the weighting function to correspond to the reference brightness level value. (b) Calculating a relative distance in accordance with a difference in brightness from the center pixel for each pixel in the input image. (c) Applying a prescribed first value to each pixel at a distance corresponding to a first area from the center pixel as a weight value. (d) Inhibiting the application of a weight value depending on a distance to pixels outside the first area.

In embodiments, performing smoothing may include at least one of (a) Changing the shape of the weighting function to correspond to the reference brightness level value. (b) Calculating a relative distance in accordance with a difference in brightness from the center pixel for each pixel in the input image. (c) Applying a prescribed first value to each pixel at a geometric distance corresponding to a first area from the center pixel as a weight value, (d) Applying a weight value, which linearly decreases depending on a distance, to each pixel in a second area at a given distance from the first area.

Embodiments relate to a method of removing noise in an edge area. In accordance with embodiments, the method may include at least one of (1) Detecting edge values in the horizontal and vertical directions from an input image. (2) Extracting feature point information of the input image using the detected edge values. (3) Adjusting the parameters of a first distance-dependent weighting function for smoothing the input image using the edge values and the feature point information. (4) Adaptively adjusting a reference brightness level value of a center pixel to be smoothed in the input image on the basis of the edge values and the feature point information. (5) Determining a second weighting function depending on a difference in brightness between pixels using the reference brightness level value. (6) Performing smoothing on the input image by applying both the first weighting function and the second weighting function.

In accordance with embodiments, when processing an image signal from an image sensor mounted in a small electronic apparatus (e.g. such as a mobile apparatus), in order to remove noise, edge values are detected from an area to be smoothed to detect a feature point, weights depending on a geometric distance with respect to the feature point are applied to pixels distributed in the smoothed area, a brightness value as reference is calculated in consideration of a difference in brightness between a center pixel and a peripheral pixel, and/or the weights are applied depending on the brightness values of the pixels to perform smoothing. Therefore, it is possible to effectively remove noise while maintaining the level on the edge area, in accordance with embodiments.

While the invention has been shown and described with respect to the embodiment, it will be understood by those skilled in the art that various changes and modifications may be made without departing from the scope of the invention as defined in the following claims.

What is claimed is:

1. A device for removing noise in an edge area, the device comprising:
an edge detection unit which detects edge values in the horizontal and vertical directions from an input image and extracts feature point information of the input image using the detected edge values;
a parameter adaptation unit configured to adjust the parameters of a distance-dependent weighting function for smoothing of the input image using the edge values detected by the edge detection unit and the feature point information and
a bilateral filter unit configured to perform smoothing on the input image using the distance-dependent weighting function, to which the parameters adjusted by the parameter adaptation unit are applied.

2. The device of claim 1, wherein the bilateral filter unit changes the shape of the weighting function to correspond to the adjusted parameters.

3. The device of claim 2, wherein the bilateral filter unit performs smoothing by applying the corresponding value of the weighting function depending on a geometric distance from the feature point to each pixel in the input image as a weight value.

4. The device of claim 3, wherein the weighting function is a Gaussian function.

5. A device for removing noise in an edge area, the device comprising:
an edge detection unit which detects edge values in the horizontal and vertical directions from an input image and extracts feature point information of the input image using the detected edge values;
a level adaptation unit which adjusts a reference brightness level value of a center pixel to be smoothed in the input image on the basis of the edge values and the feature point information; and
a bilateral filter unit which determines a weighting function depending on a difference in brightness between pixels using the reference brightness level value adjusted by the level adaptation unit, and performs smoothing on the input image using the determined weighting function.

6. The device of claim 5, wherein the bilateral filter unit changes the shape of the weighting function to correspond to the reference brightness level value.

7. The device of claim 6, wherein the bilateral filter unit:
calculates a relative distance in accordance with a difference in brightness from the center pixel for, each pixel in the input image; and
performs smoothing by applying the corresponding value of the weighting function depending on the calculated distance as a weight value.

8. The device of claim 5 wherein the weighting function is a Gaussian function.

9. The device of claim 5, wherein the bilateral filter unit:
calculates a relative distance in accordance with a difference in brightness from the center pixel for each pixel in the input image;
applies a prescribed first value to a pixel at a distance corresponding to a first area from the center pixel as a weight value; and
inhibits the application of a weight value depending on a distance to a pixel outside the first area.

10. The device of claim 5, wherein the bilateral filter unit:
calculates a relative distance in accordance with a difference in brightness from the center pixel for each pixel in the input image;
applies a prescribed first value to each pixel at a geometric distance corresponding to a first area from the center pixel as a weight value; and
applies a weight value, which linearly decreases depending on a distance, to each pixel in a second area at a given distance from the first area.

11. The device of claim 9, wherein the bilateral filter unit applies a weight value depending on a geometric distance from the center pixel before applying a weighting function depending on the difference in brightness to each pixel of the input image.

12. A method of removing noise in an edge area, the method comprising:
detecting edge values in the horizontal and vertical directions from an input image,
extracting feature point information of the input image using the detected edge values;
adjusting the parameters of a distance-dependent weighting function for smoothing of the input image using the edge values and the feature point information; and
performing smoothing on the input image using the weighting function, to which the adjusted parameters are applied.

13. The method of claim 11, wherein said performing smoothing includes:
changing the shape of the weighting function to correspond to the adjusted parameters; and
performing smoothing by applying the corresponding value of the weighting function by a geometric distance from the feature point to each pixel in the input image as a weight value.

14. The method of claim 1 wherein the weighting function is a Gaussian function.

15. A method of removing noise in an edge area, the method comprising:
detecting edge values in the horizontal and vertical directions from an input image;
extracting feature point information of the input image using the detected edge value;
adjusting a reference brightness level value of a center pixel to be smoothed in the input image on the basis of the edge values and the feature point information; and
determining a weighting function depending on a difference in brightness between pixels using the reference brightness level value and performing smoothing on the input image using the weighting function.

16. The method of claim 15, wherein said performing smoothing includes:
changing the shape of the weighting function to correspond to the reference brightness level value;
calculating a relative distance in accordance with a difference in brightness from the center pixel for each pixel in the input image; and
performing smoothing by applying the corresponding value of the weighting function depending on the calculated distance as a weight value.

17. The method of claim 16, wherein the weighting function is a Gaussian function.

18. The method of claim 15, wherein said performing smoothing includes:
changing the shape of the weighting function to correspond to the reference brightness level value;
calculating a relative distance in accordance with a difference in brightness from the center pixel for each pixel in the input image;
applying a prescribed first value to each pixel at a distance corresponding to a first area from the center pixel as a weight value; and
inhibiting the application of a weight value depending on a distance to pixels outside the first area.

19. The method of claim 15, wherein said performing smoothing includes:
changing the shape of the weighting function to correspond to the reference brightness level value;
calculating a relative distance in accordance with a difference in brightness from the center pixel for each pixel in the input image;
applying a prescribed first value to each pixel at a geometric distance corresponding to a first area from the center pixel as a weight value; and
applying a weight value, which linearly decreases depending on a distance, to each pixel in a second area at a given distance from the first area.

20. A method of removing noise in an edge area, the method comprising:
detecting edge values in the horizontal and vertical directions from an input image;
extracting feature point information of the input image using the detected edge values;
adjusting the parameters of a first distance-dependent weighting function for smoothing the input image using the edge values and the feature point information;
adaptively adjusting a reference brightness level value of a center pixel to be smoothed in the input image on the basis of the edge values and the feature point information;
determining a second weighting function depending on a difference in brightness between pixels using the reference brightness level value; and
performing smoothing on the input image by applying both the first weighting function and the second weighting function.
